(19) United States
(12) Patent Application Publication
(10) Pub. No.: US 2024/0103025 A1
(43) Pub. Date: Mar. 28, 2024

(54) SYSTEMS AND APPROACHES FOR DRUG PROCESSING

(71) Applicant: AMGEN INC., Thousand Oaks, CA (US)

(72) Inventor: Jeffrey C. Yeary, Thousand Oaks, CA (US)

(21) Appl. No.: 18/275,550

(22) PCT Filed: Feb. 1, 2022
(86) PCT No.: PCT/US22/14656

§ 371 Date: Aug. 2, 2023

Related U.S. Application Data
(60) Provisional application No. 63/145,245, filed on Feb. 3, 2021.

(51) Int. Cl. G01N 35/00; G01N 35/04; G01N 35/10

(52) U.S. Cl. CPC G01N 35/0099; G01N 35/04; G01N 35/1065; G01N 2035/00524; G01N 2035/0418

(57) ABSTRACT

A drug processing system includes a workstation, at least one deck module movably positionable within the workstation, at least one filter plate operably coupled with the at least one deck module, an agitating member, and a liquid handler member. The at least one filter plate has a plurality of wells to receive a fluid therein. The agitating member is adapted to move the at least one filter plate according to an agitation system. The liquid handler member is adapted to selectively add a fluid to at least one of the plurality of wells and/or remove a fluid from the at least one of the plurality of wells according to a liquid handling system. The agitating member is adapted to move the at least one filter plate while the liquid handler member selectively adds and/or removes the fluid from the at least one of the plurality of wells.

### CROSS-REFERENCE TO RELATED APPLICATION

Priority is claimed to U.S. Provisional Patent Application No. 63/145,245, filed Feb. 3, 2021, the entire contents of which are hereby expressly incorporated by reference herein.

### FIELD OF DISCLOSURE

The present disclosure generally relates to drug preparation systems, and, more particularly, to approaches for automated reconstitution of drug substances and drug products.

### BACKGROUND

Flexible multipurpose automated laboratory equipment that incorporates robotics may be used for a number of purposes such as, for example, a liquid handler, a Viscometer, and a Micro Buffer Exchange (“MBX”). In some examples, the MBX may exchange as many as 48 450 μL formulations using specific filter plates, volume check devices, and pressure chambers to urge the transfer of excipients. Formulations may also be concentrated with duplicates being pooled at the end of the MBX process. While these systems may be customizable and extensible, these systems may require complicated setups processes, they may require skilled individuals to properly operate, and may require extensive software development. These challenges may lead to inefficiencies during all stages of processing. More specifically, many existing systems have difficulty with meeting targeted concentration values for a number of reasons, and may result in efficiencies of approximately 35%. As such, these systems may lead to increased processing times and may even require manual intervention, both of which may result in increased costs.

In some examples, the MBX may experience difficulty when producing suitable yields of mixed concentrations due to proteins failing to adequately become suspended in solution. Further, in some examples, after the exchange and concentration process is completed, the equipment may collect and scavenge all of the drug substance and/or drug product from each well, which may lead to a significant portion of the overall yield from the process. Additionally, some systems may incorporate a filter member or plate that is repeatedly moved to different locations during processing using a gripping member. Repeated movement of these systems can lead to the gripper dropping the filter member or plate, thus causing the experiment and the material used to be lost. Further still, existing systems may require correct placement and positioning of components, as incorrect placement may cause the robotic members to crash and cause damage to system components.

As described in more detail below, the present disclosure sets forth systems and methods for using a robotic-based reconstitution system embodying advantageous alternatives to existing systems and methods, and that may address one or more of the challenges or needs mentioned herein, as well as provide other benefits and advantages.

### SUMMARY

In accordance with a first aspect, a drug processing system includes a workstation, at least one deck module movably positionable within the workstation, at least one filter plate operably coupled with the at least one deck module, an agitating member, and a liquid handler member. The at least one filter plate has a plurality of wells to receive a fluid therein. The agitating member is adapted to move the at least one filter plate according to an agitation system. The liquid handler member is adapted to selectively add a fluid to at least one of the plurality of wells and/or remove a fluid from the at least one of the plurality of wells according to a liquid handling system. The agitating member is adapted to move the at least one filter plate while the liquid handler member selectively adds and/or removes the fluid from the at least one of the plurality of wells.

In some examples, the agitating member 116 includes a vortex plate adapted to move at a selectable speed, such as, for example, between approximately 25 revolutions per minute and approximately 300 revolutions per minute. In some forms, the liquid handling member includes a first robotic arm movable between a plurality of positions within the workstation. The liquid handling member may further include a six tip member adapted to simultaneously add and/or remove the fluid from six wells of the filter plate.

In some approaches, the system may include a plate mover. The plate mover may be adapted to move the at least one filter plate and/or the at least one deck module to a plurality of positions within the workstation. The plate mover may be in the form of a second robotic arm movable between a plurality of positions within the workstation. In some forms, the system may further include an adapter bracket. The adapter bracket may operably couple with at least a portion of the at least one filter plate and may include a sidewall member and at least one groove formed on at least a portion of the sidewall member. The at least one groove is adapted to be engaged by the plate mover during movement thereof within the workstation.

In some of these approaches, the system may further include a visual identification member disposed on at least one of the at least one deck module or the at least one filter plate.

In some forms, the system may include a memory adapted to store non-transitory computer executable instructions and a processor adapted to interface with the memory. Upon receiving a command to initiate the liquid handling system, the processor is adapted to execute the non-transitory computer executable instructions to cause the processor to automatically activate the agitation system and selectively add the fluid to at least one of the plurality of wells and/or remove the fluid from the at least one of the plurality of wells.

In some forms, the agitating member is adapted to move the at least one filter plate in a circular motion while the liquid handler member selectively adds and/or removes the fluid from the at least one of the plurality of wells.

In accordance with a second aspect, an assembly for a drug processing system includes a filter plate and an adapter bracket. The filter plate is adapted to be disposed within a workstation and includes a body defining a plurality of wells to receive a fluid therein and a sidewall extending around the body. The adapter bracket is adapted to operably couple with at least a portion of the filter plate and includes a sidewall member and at least one groove formed on at least a portion of the sidewall member. The at least one groove is dimensioned to receive a movable member adapted to selectively position the filter plate.

### BRIEF DESCRIPTION OF THE DRAWINGS

The above needs are at least partially met through provision of the systems and approaches for drug processing described in the following detailed description, particularly when studied in conjunction with the drawings, wherein:

FIG. 1 illustrates a block diagram of an example drug processing system in accordance with various embodiments;

FIG. 2 illustrates an example dispensing system positioned above an example filter plate having a plurality of wells for use in the example drug processing system of FIG. 1 in accordance with various embodiments;

FIG. 3 illustrates a top plan view of an example dispensing system inserted into an example filter plate well in accordance with various embodiments;

FIG. 4 illustrates an example filter plate having a plurality of wells for use with the example system of FIGS. 1-3 in accordance with various embodiments;

FIG. 5 illustrates a perspective view of an example adapter bracket for use with the example filter plate of FIG. 4 in accordance with various embodiments;

FIG. 6 illustrates an plate mover operably coupled with the example adapter bracket of FIG. 5 in accordance with various embodiments;

FIG. 7 illustrates an example deck module for use with the example drug processing system of FIGS. 1-6 having an example visual identification member in accordance with various embodiments;

FIG. 8 illustrates an example deck module having an example visual identification member in accordance with various embodiments; and

FIG. 9 illustrates an example workstation for use with the example system of FIGS. 1-8 in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a high-throughput approach for a robotic liquid handling platform for processing drug substances and/or drug products is provided. In some examples, the platform may be used for reconstituting lyophilized drug product is provided. The approaches described herein include implementation of new computer-implemented processes to enable new robotic tasks such as, for example, automating the process for pipetting for adding and mixing material into a well as well plate as for removing material from the well plate to pool formulations into vials as a way to increase the amount of drug concentration in solution and to increase the amount of drug recovery per well. Further, an attachment is provided that is shaped to allow a gripper to firmly and safely hold the filter plate during routine movements. Notably, the attachment includes a number of grooves along a sidewall to ensure a successful pickup and placement of the plate. Further still, a visual identifier may be used to assist with properly orienting components to ensure the robotic systems may operate within their full potential range of motion.

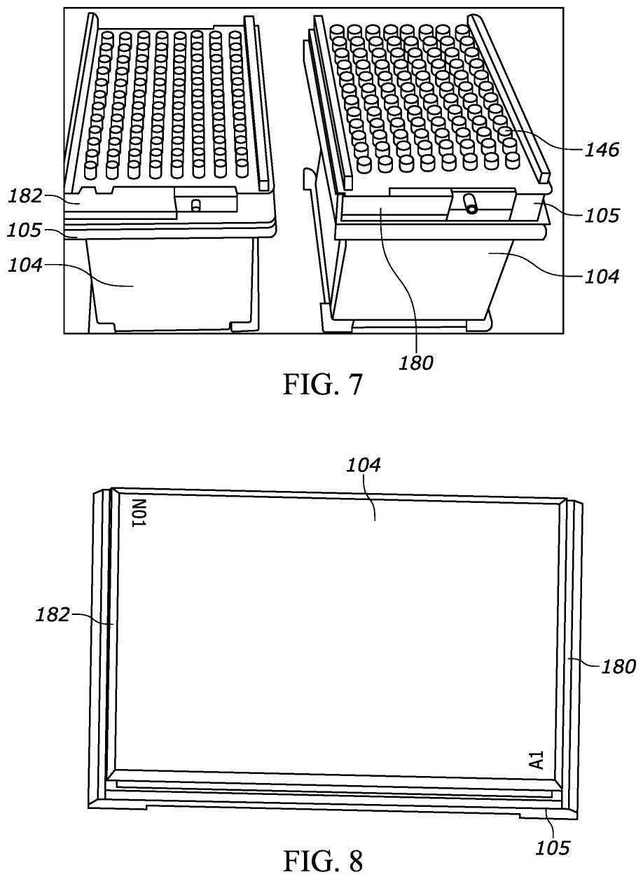

Turning to the figures, pursuant to these various embodiments, a drug processing system 100 is provided that includes a workstation 102, at least one deck module 104 (FIGS. 7 & 9) movably positionable within the workstation 102, at least one filter plate 108 operably coupled with the at least one deck module 104, an agitating member 116 disposed within the workstation 102, a computing system 120, a liquid handler member 140, and a plate mover 160. The system 100 may reconstitute, mix, aspirate or extract, and/or process a large number (e.g., hundreds) of drug vials every minute, and in some examples, can actively perform chemical analyses such as ascertaining sample protein concentrations at a similarly high rate.

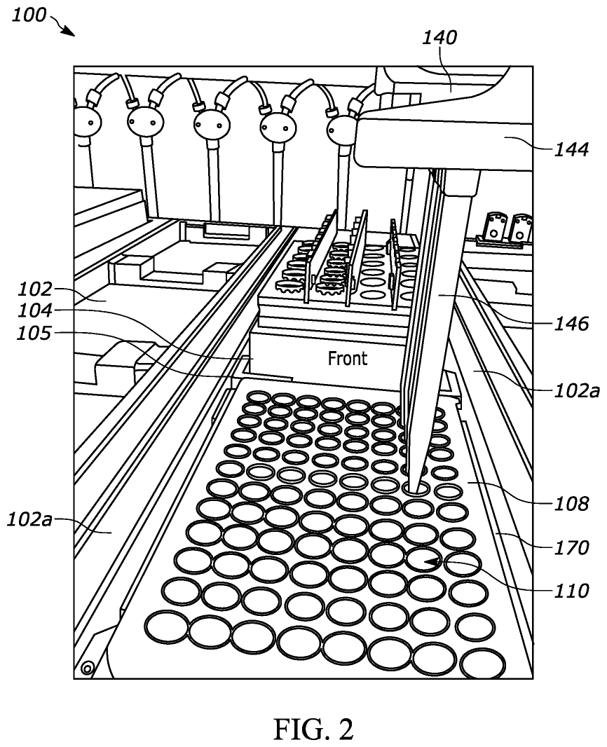

Generally, the workstation 102 is in the form of an area having a number of mounting members or rails 102a used to support the deck module or modules 104 by allowing a portion of the deck module or modules 104 to rest thereon. As illustrated in FIG. 7, the deck module or modules 104 may be in the form of a tray that includes an open volume 104a (FIGS. 2 & 9) having any desired depth to accommodate components used to process the fluid or fluids. As an example, the deck modules 104 may receive the above mentioned filter plates 108 used to mix the desired formulation, an array of vials (not illustrated) used to store the final formulation of drug product, an array of dispensing tools such as, for example, pipettes 146 (FIGS. 2, 7, & 9) used to dispense, mix, and/or aspirate the drug product, and the like. The deck modules 104 may further include an outwardly-extending ledge 105 that rests upon the rails 102a when the deck modules 104 are positioned within the workstation 102. So configured, modular nature of the deck modules 104 provide for may be movably placed at desired locations within the workstation 102 to accommodate varying functions and/or process workflows.

The agitating member 116 is disposed in the workstation 102 at a desired location. In some examples, the agitating member 116 may also be a modular component, thereby allowing for movement to a desired location within the workstation. In some examples, the agitating member 116 is in the form of a vortexer used to mix the formulation at specific times such as, for example, after reconstitution of the drug product, in accordance with an agitation system. The agitating member 116 may create a circular vortex, and may be set according to a vortexing system at varying speeds such as, for example, between approximately 25 revolutions per minute and approximately 300 revolutions per minute. Other examples are possible.

The filter plate 108 is in the form of a body having a number of wells 110 used to receive proteins and other material used to form the drug solution. In some examples, each filter plate 108 may include 96 wells 110, though other examples are possible. The filter plate 108 includes a sidewall 109 extending around the body which, in some examples, is in the form of a ledge that may rest on a portion of a desired deck module 104. In other examples, the sidewall 109 may be directly positionable on the mounting member 102a of the workstation 102 if placement within a deck module 104 is not desired. As illustrated in FIG. 6, the filter plate 108 (which is covered by a lid 111) may include any number of legs 112 which extend downwardly from the sidewall 109. In some examples, these legs 112 may be used to position the filter plate 108 within the deck module 104 and/or the workstation 102. Further, the filter plate 108 may be positioned on and/or secured with the agitating member 116 such that the agitating member may create and/or apply a force such as a circular force, imparting a motion such as a circular motion on the filter plate 109 and to the contents within each of the wells 110. Other arrangements are possible.

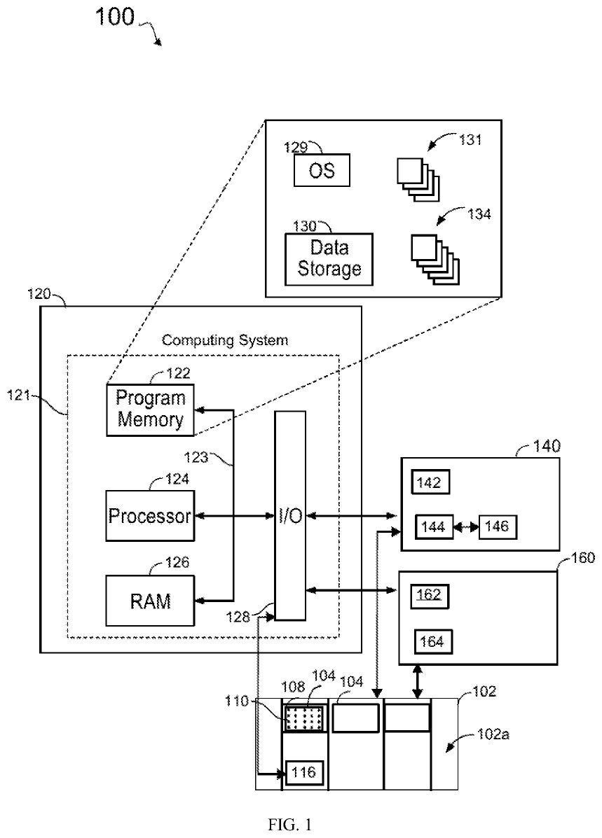

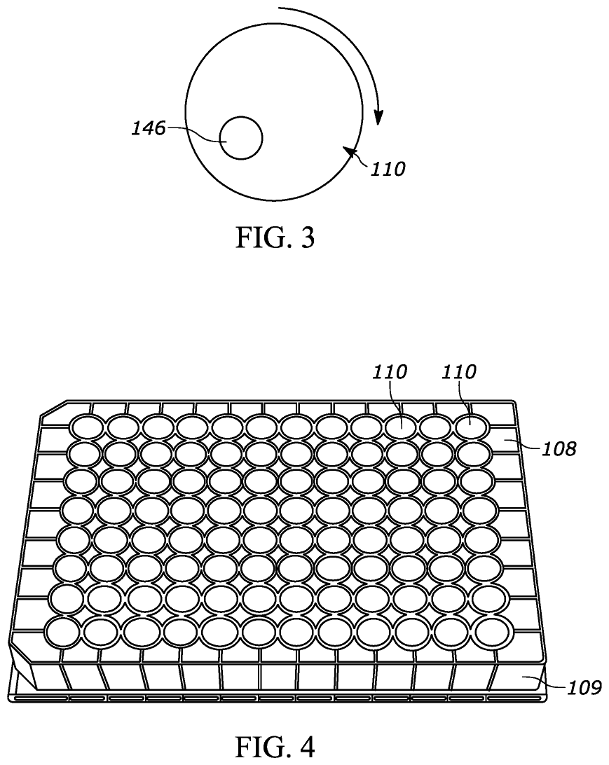

In some examples, the liquid handler member 140 and the plate mover 160 are both in the form of robotic arms which are movable between a number of positions within the confines of a three-dimensional area above the workstation 102. In some examples and as illustrated in FIG. 3, the liquid handler member 140 is used to add a fluid to (i.e., to reconstitute) and/or remove a fluid from the wells 110 while the filter plate 108 is positioned on the deck module 104. In some examples and as illustrated in the schematic of FIG. 1, the liquid handler member 140 includes any number of motors 142, and a fluid line assembly 144 having a number of ports to fluidly couple with a dispensing system 146 in the form of a pipette or pipettes 146. In the illustrated examples, a six tip dispensing system 146 is provided in the form of six pipettes capable of transferring fluid to and from six wells 110 simultaneously. The fluid line assembly 144 is in fluid communication with a fluid reservoir (not illustrated). The liquid handler member 140 is responsive to a set of instructions or commands to initiate and execute a dispensing, mixing, and aspiration system. The motor or motors 142 may move the liquid handler member 140 in the three dimensional space defined by the system 100, and move the dispensing system 146 towards a desired filter plate 108 (more specifically towards a desired well or wells 110 thereon) and selectively dispense a fluid into the wells 110 or draw a fluid from the wells 110. The fluid reservoir may include a pumping mechanism (not illustrated) to dispense specific quantities of fluid to the fluid line assembly 144 as desired. The liquid handler member 140 may include any number of mechanical and electromechanical components, sub-components, systems, power sources, measuring devices, processors, controllers, and the like to operate in an autonomous or semi-autonomous manner.

The plate mover 160 is used to transfer and/or move the filter plate 108 (along with, or separate from the deck module 104) to different locations within the workstation 102. More specifically, as illustrated in the schematic of FIG. 1, the plate mover 160 includes any number of motors 162 and a grabber or claw 164. The plate mover 160 is responsive to a set of instructions or commands to initiate and execute a transfer system. The motor or motors 162 move the plate mover 160 in the three dimensional space defined by the system 100, and further move the grabber 164 towards a desired filter plate 108 and cause the grabber 164 to grab the sidewall 109 thereof, lift the filter plate 108 from the workstation 102 (along with, or separately from the deck module 104), and move the filter plate 108 to a different location in the workstation 102. The plate mover 160 may include any number of mechanical and electromechanical components, sub-components, systems, power sources, measuring devices, processors, controllers, and the like to operate in an autonomous or semi-autonomous manner.

The computing system 120 may be configured to execute one or more algorithms, programs, or applications to move, mix, agitate, reconstitute, aspirate, collect, or otherwise analyze the contents contained within the well 110. More specifically, one or more applications may generate or implement control commands to control the agitating member 116, the liquid handler member 140, and/or the plate mover 160, such as components that control the movement thereof, dispensing or aspirating of particular wells 110, the grasping of particular filter plates 108, and the like. To facilitate such control, the computing system 120 may be communicatively connected to the agitating member 116, the liquid handler member 140, and the plate mover 160 by various electrical or electromechanical connections. When a control command is generated by the computing system 120, it may thus be communicated to the control components of the agitating member 116, the liquid handler member 140, and the plate mover 160 to effect a control action.

The computing system 120 may include a controller 121 including a program memory 122, one or more processors 124 (e.g., microcontrollers or microprocessors), a RAM 126, and an interface I/O circuit 128, all of which are interconnected via an address/data bus 123. The program memory 122 may include an operating system 129, a data storage 130, a plurality of software applications 131, and/or a plurality of software routines 134 or systems. In some examples, the operating system 129 may include one of a plurality of general purpose or mobile platforms, such as the Windows®, macOS®, Android™, iOS®, or other custom operating system designed for drug processing using the computing system 120. The data storage 130 may include data such as user profiles and preferences, application data for the plurality of applications 131, routine data for the plurality of routines 134, and other data. In some embodiments, the controller 121 may also include, or otherwise be communicatively connected to, other data storage mechanisms (not shown), such as hard disk drives, optical storage drives, or solid state storage devices located within the system 100.

It should be appreciated that although FIG. 1 depicts a single processor 124, the controller 121 may include multiple processors 124. The processor 124 may be configured to execute any of one or more of the plurality of software applications 131 or any one or more of the plurality of software routines 134 residing in the program memory 122, in addition to other software applications. Similarly, the controller 121 may include multiple RAMs 126 and multiple program memories 122. The RAM 126 and program memory 122 may be semiconductor memories, magnetically readable memories, or optically readable memories, for example.

The data storage 130 may store various software applications 131 implemented as machine-readable instructions, which may include a liquid handling system or application, an agitation system or application, and a transfer system or application. The liquid handling system may cause the liquid handler member 140 to dispense contents into a desired well or wells 110. The agitation system may cause the agitation member 116 to generate a vortex to mix the contents within the well or wells 110. The transfer system may cause the plate mover 160 to move or transfer a filter plate 108. The generated control command may be communicated to the control components of the system 100 to effect a control action. The various software applications may be executed by the same computer processor 124 or by different computer processors. The various software applications 131 may call various software routines 134 to execute the various software applications 131.

In operation, and as illustrated in FIG. 3, during a mixing process, a number of fluids are added to the desired well or wells 110 via the dispensing system 146. During this mixing process, the agitation member 116 may rotate at a desired speed (e.g., approximately 100 rotations per minute) to generate a vortex. The process of adding fluids while swirling the well or wells 110 causes higher concentrated proteins disposed at the bottom of the well 110 to draw up into the solution. So configured, using the agitation member 116 during the mixing process may increase an overall concentration by approximately 5 mg/mL. This mixing process may be incorporated into a six tip dispensing system 146.

Similarly, during an aspiration process, the agitation member 116 may also rotate at a desired speed (e.g., approximately 100 rotations per minute) to generate a vortex. The dispensing system 146 may aspirate or pool the fluid from the well or wells 110 during this movement. Because of the motion generated by the agitation member 116, the higher concentrated material disposed in the well 110 may be more easily drawn into the dispensing system 146 to be used for further processing (e.g., to dispense into 6, 12, 24, or 48 drug vials). So configured, using the agitation member 116 during the aspiration process may increase an overall yield by approximately 15 μL per well. This pooling process may be incorporated into a six tip dispensing system 146.

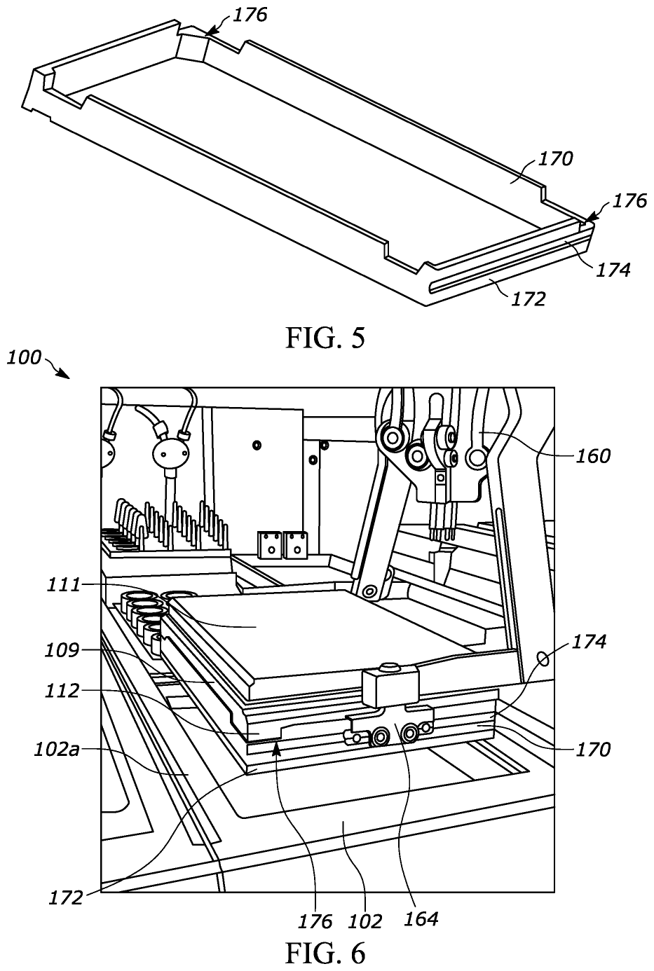

With reference to FIGS. 4-6, an adapter bracket 170 is provided. The adapter bracket 170 includes a sidewall member 172 and at least one groove 174 formed on at least a portion of the sidewall member 172. The adapter bracket 170 may be constructed from any number of materials such as, for example a 3D printed polymer. Other examples are possible. As illustrated in FIG. 6, the adapter bracket 170 is dimensioned to couple with the filter plate 108 by placing the sidewall member 172 around the sidewall 109 of the filter plate 108. In some examples, the adapter bracket 170 may form a friction-fit coupling with the filter plate 108. Further, as illustrated in FIGS. 5 and 6, the adapter bracket 170 may include at least one receiving region 176 in the form of a cutout formed in the sidewall member 172. This receiving region 176 may receive the leg 112 of the filter plate 108 to assist with relative alignment. In some examples, the filter plate 108 may include fewer than four legs 112 (e.g., two legs 112) such that the placement of the legs 112 is not symmetrical about the entire filter plate 108. As such, the filter plate 108 may only be coupled with the adapter bracket 170 in one orientation. Such a configuration may assist with ensuring proper placement and positioning of the filter plate 108 relative to the deck module 104 and/or the workstation 102.

In use, the grabber 164 of the plate mover 160 may include inwardly-oriented protrusions that engage with the groove 174 formed on the sidewall member 172. Such an arrangement, combined with an inwardly directed grasping or squeezing force exerted by the grabber 164 of the plate member 160 on the adapter bracket 170 (and thus the filter member 108), may assist the grabber 164 with retaining the filter member 108 during routine movements, thereby reducing and/or eliminating an occurrence of inadvertently dropping the filter plate 108.

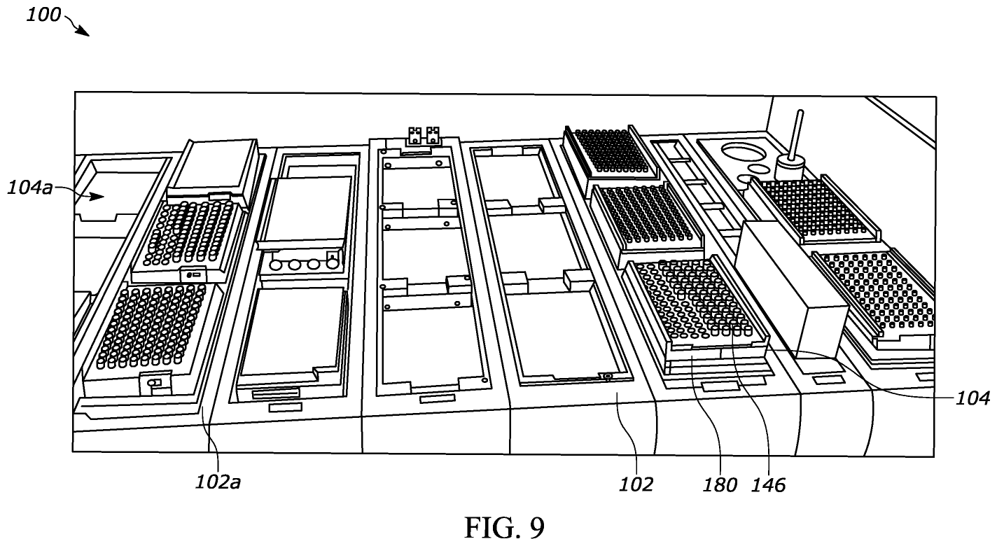

With reference to FIGS. 7-9, a visual identification member 180 is provided to reduce and/or eliminate incorrect placement of the deck module 104 within the workstation 102. More specifically, a portion of the deck module 104 (e.g., the ledge 105) may receive a visual identifier in the form of a color coded region having a different color than the remainder of the deck module 104. For example, the visual identification member 180 may be in the form of a green region that is representative of the front of the deck module 104. Further, a second visual identification member 182 may be provided in the form of a red region disposed on an opposing end of the deck module 104. So configured, a user may readily identify whether the deck module 104 is properly disposed within the workstation 102 by determining whether the first, green visual identification member 180 is visible while the deck module 104 is disposed within the workstation 102 or whether the second, red visual identification member 182 is visible while the deck module 104 is disposed within the workstation 102. If the second visual identification member 182 is visible while the deck module 104 is disposed within the workstation 102, the deck module is incorrectly oriented therein, and need be repositioned to ensure the liquid handler member 140, the plate mover 160, and/or any other components do not inadvertently strike the deck module 104 and/or any contents contained thereon. In some examples, the visual identification members 180, 182 may be formed from an anodized material. In other examples, the visual identification members 180, 182 may be in the form of labels applied to the deck module 104. Further still, in some examples, the visual identification members 180, 182 may be coupled with the filter plates 108 or any other components of the system 100.

So configured, the systems and approaches described herein may provide an efficient processing system capable of safely mixing, aspirating, and processing drug substances and/or drug products. By incorporating a vortexing step during mixing, greater concentrations of drug solution may be produced. Similarly, by incorporating a vortexing step during aspiration, additional quantities of drug solution may be drawn from the well to be used as desired.

It will be appreciated that the systems and approaches described herein may be used for the storage and transport of drugs in various states, such as but not limited to drug products which have undergone completion of mixing and/or other finishing steps, drug substances which are intended to be mixed and/or finished after shipping, components or ingredients to be used in a drug, or other drug-related states or components.

The above description describes various devices, assemblies, components, subsystems and methods for use related to a drug delivery device. The devices, assemblies, components, subsystems, methods or drug delivery devices can further comprise or be used with a drug including but not limited to those drugs identified below as well as their generic and biosimilar counterparts. The term drug, as used herein, can be used interchangeably with other similar terms and can be used to refer to any type of medicament or therapeutic material including traditional and non-traditional pharmaceuticals, nutraceuticals, supplements, biologics, biologically active agents and compositions, large molecules, biosimilars, bioequivalents, therapeutic antibodies, polypeptides, proteins, small molecules and generics. Non-therapeutic injectable materials are also encompassed. The drug may be in liquid form, a lyophilized form, or in a reconstituted from lyophilized form. The following example list of drugs should not be considered as all-inclusive or limiting.

The drug will be contained in a reservoir. In some instances, the reservoir is a primary container that is either filled or pre-filled for treatment with the drug. The primary container can be a vial, a cartridge or a pre-filled syringe.

In some embodiments, the reservoir of the drug delivery device may be filled with or the device can be used with colony stimulating factors, such as granulocyte colony-stimulating factor (G-CSF). Such G-CSF agents include but are not limited to Neulasta® (pegfilgrastim, pegylated filgastrim, pegylated G-CSF, pegylated hu-Met-G-CSF) and Neupogen® (filgrastim, G-CSF, hu-MetG-CSF), UDENYCA® (pegfilgrastim-cbqv), Ziextenzo® (LA-EP2006; pegfilgrastim-bmez), or FULPHILA (pegfilgrastim-bmez).

In other embodiments, the drug delivery device may contain or be used with an erythropoiesis stimulating agent (ESA), which may be in liquid or lyophilized form. An ESA is any molecule that stimulates erythropoiesis. In some embodiments, an ESA is an erythropoiesis stimulating protein. As used herein, “erythropoiesis stimulating protein” means any protein that directly or indirectly causes activation of the erythropoietin receptor, for example, by binding to and causing dimerization of the receptor. Erythropoiesis stimulating proteins include erythropoietin and variants, analogs, or derivatives thereof that bind to and activate erythropoietin receptor; antibodies that bind to erythropoietin receptor and activate the receptor; or peptides that bind to and activate erythropoietin receptor. Erythropoiesis stimulating proteins include, but are not limited to, Epogen® (epoetin alfa), Aranesp® (darbepoetin alfa), Dynepo® (epoetin delta), Mircera® (methyoxy polyethylene glycol-epoetin beta), Hematide®, MRK-2578, INS-22, Retacrit® (epoetin zeta), Neorecormon® (epoetin beta), Silapo® (epoetin zeta), Binocrit® (epoetin alfa), epoetin alfa Hexal, Abseamed® (epoetin alfa), Ratioepo® (epoetin theta), Eporatio® (epoetin theta), Biopoin® (epoetin theta), epoetin alfa, epoetin beta, epoetin iota, epoetin omega, epoetin delta, epoetin zeta, epoetin theta, and epoetin delta, pegylated erythropoietin, carbamylated erythropoietin, as well as the molecules or variants or analogs thereof.

Among particular illustrative proteins are the specific proteins set forth below, including fusions, fragments, analogs, variants or derivatives thereof: OPGL specific antibodies, peptibodies, related proteins, and the like (also referred to as RANKL specific antibodies, peptibodies and the like), including fully humanized and human OPGL specific antibodies, particularly fully humanized monoclonal antibodies; Myostatin binding proteins, peptibodies, related proteins, and the like, including myostatin specific peptibodies; IL-4 receptor specific antibodies, peptibodies, related proteins, and the like, particularly those that inhibit activities mediated by binding of IL-4 and/or IL-13 to the receptor; Interleukin 1-receptor 1 (“IL1-R1”) specific antibodies, peptibodies, related proteins, and the like; Ang2 specific antibodies, peptibodies, related proteins, and the like; NGF specific antibodies, peptibodies, related proteins, and the like; CD22 specific antibodies, peptibodies, related proteins, and the like, particularly human CD22 specific antibodies, such as but not limited to humanized and fully human antibodies, including but not limited to humanized and fully human monoclonal antibodies, particularly including but not limited to human CD22 specific IgG antibodies, such as, a dimer of a human-mouse monoclonal hLL2 gamma-chain disulfide linked to a human-mouse monoclonal hLL2 kappa-chain, for example, the human CD22 specific fully humanized antibody in Epratuzumab, CAS registry number 501423-23-0; IGF-1 receptor specific antibodies, peptibodies, and related proteins, and the like including but not limited to anti-IGF-1R antibodies; B-7 related protein 1 specific antibodies, peptibodies, related proteins and the like (“B7RP-1” and also referring to B7H2, ICOSL, B7h, and CD275), including but not limited to B7RP-specific fully human monoclonal IgG2 antibodies, including but not limited to fully human IgG2 monoclonal antibody that binds an epitope in the first immunoglobulin-like domain of B7RP-1, including but not limited to those that inhibit the interaction of B7RP-1 with its natural receptor, ICOS, on activated T cells; IL-15 specific antibodies, peptibodies, related proteins, and the like, such as, in particular, humanized monoclonal antibodies, including but not limited to HuMax IL-15 antibodies and related proteins, such as, for instance, 145c7; IFN gamma specific antibodies, peptibodies, related proteins and the like, including but not limited to human IFN gamma specific antibodies, and including but not limited to fully human anti-IFN gamma antibodies; TALL-1 specific antibodies, peptibodies, related proteins, and the like, and other TALL specific binding proteins; Parathyroid hormone (“PTH”) specific antibodies, peptibodies, related proteins, and the like; Thrombopoietin receptor (“TPO-R”) specific antibodies, peptibodies, related proteins, and the like; Hepatocyte growth factor (“HGF”) specific antibodies, peptibodies, related proteins, and the like, including those that target the HGF/SF:cMet axis (HGF/SF:c-Met), such as fully human monoclonal antibodies that neutralize hepatocyte growth factor/scatter (HGF/SF); TRAIL-R2 specific antibodies, peptibodies, related proteins and the like; Activin A specific antibodies, peptibodies, proteins, and the like; TGF-beta specific antibodies, peptibodies, related proteins, and the like; Amyloid-beta protein specific antibodies, peptibodies, related proteins, and the like; c-Kit specific antibodies, peptibodies, related proteins, and the like, including but not limited to proteins that bind c-Kit and/or other stem cell factor receptors; OX40L specific antibodies, peptibodies, related proteins, and the like, including but not limited to proteins that bind OX40L and/or other ligands of the OX40 receptor; Activase® (alteplase, tPA); Aranesp® (darbepoetin alfa) Erythropoietin [30-asparagine, 32-threonine, 87-valine, 88-asparagine, 90-threonine], Darbepoetin alfa, novel erythropoiesis stimulating protein (NESP); Epogen® (epoetin alfa, or erythropoietin); GLP-1, Avonex® (interferon beta-1a); Bexxar® (tositumomab, anti-CD22 monoclonal antibody); Betaseron® (interferon-beta); Campath® (alemtuzumab, anti-CD52 monoclonal antibody); Dynepo® (epoetin delta); Velcade® (bortezomib); MLN0002 (anti-?4β7 mAb); MLN1202 (anti-CCR2 chemokine receptor mAb); Enbrel® (etanercept, TNF-receptor/Fc fusion protein, TNF blocker); Eprex® (epoetin alfa); Erbitux® (cetuximab, anti-EGFR/HER1/c-ErbB-1); Genotropin® (somatropin, Human Growth Hormone); Herceptin® (trastuzumab, anti-HER2/neu (erbB2) receptor mAb); Kanjinti™ (trastuzumab-anns) anti-HER2 monoclonal antibody, biosimilar to Herceptin®, or another product containing trastuzumab for the treatment of breast or gastric cancers; Humatrope® (somatropin, Human Growth Hormone); Humira® (adalimumab); Vectibix® (panitumumab), Xgeva® (denosumab), Prolia® (denosumab), Immunoglobulin G2 Human Monoclonal Antibody to RANK Ligand, Enbrel® (etanercept, TNF-receptor/Fc fusion protein, TNF blocker), Nplate® (romiplostim), rilotumumab, ganitumab, conatumumab, brodalumab, insulin in solution; Infergen® (interferon alfacon-1); Natrecor® (nesiritide; recombinant human B-type natriuretic peptide (hBNP); Kineret® (anakinra); Leukine® (sargamostim, rhuGM-CSF); LymphoCide® (epratuzumab, anti-CD22 mAb); Benlysta™ (lymphostat B, belimumab, anti-BlyS mAb); Metalyse® (tenecteplase, t-PA analog); Mircera® (methoxy polyethylene glycol-epoetin beta); Mylotarg® (gemtuzumab ozogamicin); Raptiva® (efalizumab); Cimzia® (certolizumab pegol, CDP 870); Solids™ (eculizumab); pexelizumab (anti-05 complement); Numax® (MEDI-524); Lucentis® (ranibizumab); Panorex® (17-1A, edrecolomab); Trabio® (lerdelimumab); TheraCim hR3 (nimotuzumab); Omnitarg (pertuzumab, 2C4); Osidem® (IDM-1); OvaRex® (B43.13); Nuvion® (visilizumab); cantuzumab mertansine (huC242-DM1); NeoRecormon® (epoetin beta); Neumega® (oprelvekin, human interleukin-11); Orthoclone OKT3® (muromonab-CD3, anti-CD3 monoclonal antibody); Procrit® (epoetin alfa); Remicade® (infliximab, anti-TNF? monoclonal antibody); Reopro® (abciximab, anti-GP IIb/IIIa receptor monoclonal antibody); Actemra® (anti-IL6 Receptor mAb); Avastin® (bevacizumab), HuMax-CD4 (zanolimumab); Mvasi™ (bevacizumab-awwb); Rituxan® (rituximab, anti-CD20 mAb); Tarceva® (erlotinib); Roferon-A®-(interferon alfa-2a); Simulect® (basiliximab); Prexige® (lumiracoxib); Synagis® (palivizumab); 145c7-CHO (anti-IL15 antibody, see U.S. Pat. No. 7,153,507); Tysabri® (natalizumab, anti-?4integrin mAb); Valortim® (MDX-1303, anti-B. anthracis protective antigen mAb); ABthrax™; Xolair® (omalizumab); ETI211 (anti-MRSA mAb); IL-1 trap (the Fc portion of human IgG1 and the extracellular domains of both IL-1 receptor components (the Type I receptor and receptor accessory protein)); VEGF trap (Ig domains of VEGFR1 fused to IgG1 Fc); Zenapax® (daclizumab); Zenapax® (daclizumab, anti-IL-2R? mAb); Zevalin® (ibritumomab tiuxetan); Zetia® (ezetimibe); Orencia® (atacicept, TACI-Ig); anti-CD80 monoclonal antibody (galiximab); anti-CD23 mAb (lumiliximab); BR2-Fc (huBR3/huFc fusion protein, soluble BAFF antagonist); CNTO 148 (golimumab, anti-TNF? mAb); HGS-ETR1 (mapatumumab; human anti-TRAIL Receptor-1 mAb); HuMax-CD20 (ocrelizumab, anti-CD20 human mAb); HuMax-EGFR (zalutumumab); M200 (volociximab, anti-?5?1 integrin mAb); MDX-010 (ipilimumab, anti-CTLA-4 mAb and VEGFR-1 (IMC-18F1); anti-BR3 mAb; anti-C. difficile Toxin A and Toxin B C mAbs MDX-066 (CDA-1) and MDX-1388); anti-CD22 dsFv-PE38 conjugates (CAT-3888 and CAT-8015); anti-CD25 mAb (HuMax-TAC); anti-CD3 mAb (NI-0401); adecatumumab; anti-CD30 mAb (MDX-060); MDX-1333 (anti-IFNAR); anti-CD38 mAb (HuMax CD38); anti-CD40L mAb; anti-Cripto mAb; anti-CTGF Idiopathic Pulmonary Fibrosis Phase I Fibrogen (FG-3019); anti-CTLA4 mAb; anti-eotaxin1 mAb (CAT-213); anti-FGF8 mAb; anti-ganglioside GD2 mAb; anti-ganglioside GM2 mAb; anti-GDF-8 human mAb (MYO-029); anti-GM-CSF Receptor mAb (CAM-3001); anti-HepC mAb (HuMax HepC); anti-IFN? mAb (MEDI-545, MDX-198); anti-IGF1R mAb; anti-IGF-1R mAb (HuMax-Inflam); anti-IL12 mAb (ABT-874); anti-IL12/1L23 mAb (CNTO 1275); anti-IL13 mAb (CAT-354); anti-IL2Ra mAb (HuMax-TAC); anti-IL5 Receptor mAb; anti-integrin receptors mAb (MDX-018, CNTO 95); anti-IP10 Ulcerative Colitis mAb (MDX-1100); BMS-66513; anti-Mannose Receptor/hCG? mAb (MDX-1307); anti-mesothelin dsFv-PE38 conjugate (CAT-5001); anti-PD1mAb (MDX-1106 (ONO-4538)); anti-PDGFR? antibody (IMC-3G3); anti-TGFβ mAb (GC-1008); anti-TRAIL Receptor-2 human mAb (HGS-ETR2); anti-TWEAK mAb; anti-VEGFR/Flt-1 mAb; and anti-ZP3 mAb (HuMax-ZP3).

In some embodiments, the drug delivery device may contain or be used with a sclerostin antibody, such as but not limited to romosozumab, blosozumab, BPS 804 (Novartis), Evenity™ (romosozumab-aqqg), another product containing romosozumab for treatment of postmenopausal osteoporosis and/or fracture healing and in other embodiments, a monoclonal antibody (IgG) that binds human Proprotein Convertase Subtilisin/Kexin Type 9 (PCSK9). Such PCSK9 specific antibodies include, but are not limited to, Repatha® (evolocumab) and Praluent® (alirocumab). In other embodiments, the drug delivery device may contain or be used with rilotumumab, bixalomer, trebananib, ganitumab, conatumumab, motesanib diphosphate, brodalumab, vidupiprant or panitumumab. In some embodiments, the reservoir of the drug delivery device may be filled with or the device can be used with IMLYGIC® (talimogene laherparepvec) or another oncolytic HSV for the treatment of melanoma or other cancers including but are not limited to OncoVEXGALV/CD; OrienX010; G207, 1716; NV1020; NV12023; NV1034; and NV1042. In some embodiments, the drug delivery device may contain or be used with endogenous tissue inhibitors of metalloproteinases (TIMPs) such as but not limited to TIMP-3. In some embodiments, the drug delivery device may contain or be used with Aimovig® (erenumab-aooe), anti-human CGRP-R (calcitonin gene-related peptide type 1 receptor) or another product containing erenumab for the treatment of migraine headaches. Antagonistic antibodies for human calcitonin gene-related peptide (CGRP) receptor such as but not limited to erenumab and bispecific antibody molecules that target the CGRP receptor and other headache targets may also be delivered with a drug delivery device of the present disclosure. Additionally, bispecific T cell engager (BITE®) molecules such as but not limited to BLINCYTO® (blinatumomab) can be used in or with the drug delivery device of the present disclosure. In some embodiments, the drug delivery device may contain or be used with an APJ large molecule agonist such as but not limited to apelin or analogues thereof. In some embodiments, a therapeutically effective amount of an anti-thymic stromal lymphopoietin (TSLP) or TSLP receptor antibody is used in or with the drug delivery device of the present disclosure. In some embodiments, the drug delivery device may contain or be used with Avsola™ (infliximab-axxq), anti-TNF? monoclonal antibody, biosimilar to Remicade® (infliximab) (Janssen Biotech, Inc.) or another product containing infliximab for the treatment of autoimmune diseases. In some embodiments, the drug delivery device may contain or be used with Kyprolis® (carfilzomib), (2S)—N—((S)-1-((S)-4-methyl-14(R)-2-methyloxiran-2-yl)-1-oxopentan-2-ylcarbamoyl)-2-phenylethyl)-2-((S)-2-(2-morpholinoacetamido)-4-phenylbutanamido)-4-methylpentanamide, or another product containing carfilzomib for the treatment of multiple myeloma. In some embodiments, the drug delivery device may contain or be used with Otezla® (apremilast), N-[2-[(1S)-1-(3-ethoxy-4-methoxyphenyl)-2-(methylsulfonyl)ethyl]-2,3-dihydro-1,3-dioxo-1H-isoindol-4-yl]acetamide, or another product containing apremilast for the treatment of various inflammatory diseases. In some embodiments, the drug delivery device may contain or be used with Parsabiv™ (etelcalcetide HCl, KAI-4169) or another product containing etelcalcetide HCl for the treatment of secondary hyperparathyroidism (sHPT) such as in patients with chronic kidney disease (KD) on hemodialysis. In some embodiments, the drug delivery device may contain or be used with ABP 798 (rituximab), a biosimilar candidate to Rituxan®/MabThera™, or another product containing an anti-CD20 monoclonal antibody. In some embodiments, the drug delivery device may contain or be used with a VEGF antagonist such as a non-antibody VEGF antagonist and/or a VEGF-Trap such as aflibercept (Ig domain 2 from VEGFR1 and Ig domain 3 from VEGFR2, fused to Fc domain of IgG1). In some embodiments, the drug delivery device may contain or be used with ABP 959 (eculizumab), a biosimilar candidate to Soliris®, or another product containing a monoclonal antibody that specifically binds to the complement protein C5. In some embodiments, the drug delivery device may contain or be used with Rozibafusp alfa (formerly AMG 570) is a novel bispecific antibody-peptide conjugate that simultaneously blocks ICOSL and BAFF activity. In some embodiments, the drug delivery device may contain or be used with Omecamtiv mecarbil, a small molecule selective cardiac myosin activator, or myotrope, which directly targets the contractile mechanisms of the heart, or another product containing a small molecule selective cardiac myosin activator. In some embodiments, the drug delivery device may contain or be used with Sotorasib (formerly known as AMG 510), a KRASG12C small molecule inhibitor, or another product containing a KRASG12C small molecule inhibitor. In some embodiments, the drug delivery device may contain or be used with Tezepelumab, a human monoclonal antibody that inhibits the action of thymic stromal lymphopoietin (TSLP), or another product containing a human monoclonal antibody that inhibits the action of TSLP. In some embodiments, the drug delivery device may contain or be used with AMG 714, a human monoclonal antibody that binds to Interleukin-15 (IL-15) or another product containing a human monoclonal antibody that binds to Interleukin-15 (IL-15). In some embodiments, the drug delivery device may contain or be used with AMG 890, a small interfering RNA (siRNA) that lowers lipoprotein(a), also known as Lp(a), or another product containing a small interfering RNA (siRNA) that lowers lipoprotein(a). In some embodiments, the drug delivery device may contain or be used with ABP 654 (human IgG1 kappa antibody), a biosimilar candidate to Stelara®, or another product that contains human IgG1 kappa antibody and/or binds to the p40 subunit of human cytokines interleukin (IL)-12 and IL-23. In some embodiments, the drug delivery device may contain or be used with Amjevita™ or Amgevita™ (formerly ABP 501) (mab anti-TNF human IgG1), a biosimilar candidate to Humira®, or another product that contains human mab anti-TNF human IgG1. In some embodiments, the drug delivery device may contain or be used with AMG 160, or another product that contains a half-life extended (HLE) anti-prostate-specific membrane antigen (PSMA)×anti-CD3 BiTE® (bispecific T cell engager) construct. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 119, or another product containing a delta-like ligand 3 (DLL3) CART (chimeric antigen receptor T cell) cellular therapy. In some embodiments, the drug delivery device may contain or be used with AMG 133, or another product containing a gastric inhibitory polypeptide receptor (GIPR) antagonist and GLP-1R agonist. In some embodiments, the drug delivery device may contain or be used with AMG 171 or another product containing a Growth Differential Factor 15 (GDF15) analog. In some embodiments, the drug delivery device may contain or be used with AMG 176 or another product containing a small molecule inhibitor of myeloid cell leukemia 1 (MCL-1). In some embodiments, the drug delivery device may contain or be used with AMG 199 or another product containing a half-life extended (HLE) bispecific T cell engager construct (BITE®). In some embodiments, the drug delivery device may contain or be used with AMG 256 or another product containing an anti-PD-1×IL21 mutein and/or an IL-21 receptor agonist designed to selectively turn on the Interleukin 21 (IL-21) pathway in programmed cell death-1 (PD-1) positive cells. In some embodiments, the drug delivery device may contain or be used with AMG 330 or another product containing an anti-CD33×anti-CD3 BiTE® (bispecific T cell engager) construct. In some embodiments, the drug delivery device may contain or be used with AMG 404 or another product containing a human anti-programmed cell death-1(PD-1) monoclonal antibody being investigated as a treatment for patients with solid tumors. In some embodiments, the drug delivery device may contain or be used with AMG 427 or another product containing a half-life extended (HLE) anti-fms-like tyrosine kinase 3 (FLT3)×anti-CD3 BiTE® (bispecific T cell engager) construct. In some embodiments, the drug delivery device may contain or be used with AMG 430 or another product containing an anti-Jagged-1 monoclonal antibody. In some embodiments, the drug delivery device may contain or be used with AMG 506 or another product containing a multi-specific FAP×4-1BB-targeting DARPin® biologic under investigation as a treatment for solid tumors. In some embodiments, the drug delivery device may contain or be used with AMG 509 or another product containing a bivalent T-cell engager and is designed using XmAb® 2+1 technology. In some embodiments, the drug delivery device may contain or be used with AMG 562 or another product containing a half-life extended (HLE) CD19×CD3 BiTE® (bispecific T cell engager) construct. In some embodiments, the drug delivery device may contain or be used with Efavaleukin alfa (formerly AMG 592) or another product containing an IL-2 mutein Fc fusion protein. In some embodiments, the drug delivery device may contain or be used with AMG 596 or another product containing a CD3× epidermal growth factor receptor vIII (EGFRvIII) BiTE® (bispecific T cell engager) molecule. In some embodiments, the drug delivery device may contain or be used with AMG 673 or another product containing a half-life extended (HLE) anti-CD33×anti-CD3 BiTE® (bispecific T cell engager) construct. In some embodiments, the drug delivery device may contain or be used with AMG 701 or another product containing a half-life extended (HLE) anti-B-cell maturation antigen (BCMA)×anti-CD3 BiTE® (bispecific T cell engager) construct. In some embodiments, the drug delivery device may contain or be used with AMG 757 or another product containing a half-life extended (HLE) anti-delta-like ligand 3 (DLL3)×anti-CD3 BiTE® (bispecific T cell engager) construct. In some embodiments, the drug delivery device may contain or be used with AMG 910 or another product containing a half-life extended (HLE) epithelial cell tight junction protein claudin 18.2×CD3 BiTE® (bispecific T cell engager) construct.

Although the drug delivery devices, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. A drug processing system comprising:
a workstation;
at least one deck module movably positionable within the workstation;
at least one filter plate operably coupled with the at least one deck module, the at least one filter plate having a plurality of wells to receive a fluid therein;
an agitating member adapted to move the at least one filter plate according to an agitation system; and
a liquid handler member adapted to selectively add a fluid to at least one of the plurality of wells and/or remove a fluid from the at least one of the plurality of wells according to a liquid handling system;
wherein the agitating member is adapted to move the at least one filter plate while the liquid handler member selectively adds and/or removes the fluid from the at least one of the plurality of wells.

2. The drug processing system of claim 1, wherein the agitating member comprises a vortex plate adapted to move at a selectable speed.

3. The drug processing system of claim 2, wherein the vortex plate is adapted to move between approximately 25 revolutions per minute and approximately 300 revolutions per minute.

4. The drug processing system of claim 1, wherein the liquid handling member comprises a first robotic arm movable between a plurality of positions within the workstation.

5. The drug processing system of claim 4, wherein the liquid handling member further comprises a six tip member adapted to simultaneously add and/or remove the fluid from six wells of the filter plate.

6. The drug processing system of claim 1, further comprising a plate mover adapted to move the at least one filter plate and/or the at least one deck module to a plurality of positions within the workstation.

7. The drug processing system of claim 6, wherein the plate mover comprises a second robotic arm movable between a plurality of positions within the workstation.

8. The drug processing system of claim 6, further comprising an adapter bracket adapted to operably couple with at least a portion of the at least one filter plate, the adapter bracket including a sidewall member and at least one groove formed on at least a portion of the sidewall member, wherein the at least one groove is adapted to be engaged by the plate mover during movement thereof within the workstation.

9. The drug processing system of claim 1, further comprising a visual identification member disposed on at least one of the at least one deck module or the at least one filter plate.

10. The drug processing system of claim 1, further comprising:
a memory adapted to store non-transitory computer executable instructions; and
a processor adapted to interface with the memory, wherein upon receiving a command to initiate the liquid handling system, the processor is adapted to execute the non-transitory computer executable instructions to cause the processor to automatically activate the agitation system and selectively add the fluid to at least one of the plurality of wells and/or remove the fluid from the at least one of the plurality of wells.

11. The drug processing system of claim 1, wherein the agitating member is adapted to move the at least one filter plate in a circular motion while the liquid handler member selectively adds and/or removes the fluid from the at least one of the plurality of wells.

12. An assembly for a drug processing system, the assembly including:
a filter plate adapted to be disposed within a workstation, the filter plate having a body defining a plurality of wells to receive a fluid therein and a sidewall extending around the body; and
an adapter bracket adapted to operably couple with at least a portion of the filter plate, the adapter bracket including a sidewall member and at least one groove formed on at least a portion of the sidewall member, the at least one groove dimensioned to receive a movable member adapted to selectively position the filter plate.

13. The assembly of claim 12, wherein the movable member comprises a robotic arm movable between a plurality of positions.

14. The assembly of claim 13, wherein the movable member includes a grabber adapted to engage the at least one groove formed on the adapter bracket.

15. The assembly of claim 12, wherein the adapter bracket operably couples with the filter plate via a friction-fit connection.

16. The assembly of claim 12, wherein the filter plate includes at least one leg extending downwardly from the body and the adapter bracket includes at least one receiving region dimensioned to receive the at least one leg to align the filter plate within the adapter bracket.
